(19) United States
(12) Patent Application Publication
(10) Pub. No.: US 2026/0152095 A1
(43) Pub. Date: Jun. 4, 2026

(54) FUEL CELL VEHICLE AND METHOD OF CONTROLLING THE SAME

(71) Applicants: HYUNDAI MOTOR COMPANY, Seoul (KR); KIA CORPORATION, Seoul (KR)

(72) Inventors: Yoon Tae Kim, Hwaseong-si (KR); Woo Young Lee, Hwaseong-si (KR); Jong Jun Lee, Hwaseong-si (KR); Hyeon Ju Jeong, Hwaseong-si (KR); Jae Ho Kim, Hwaseong-si (KR); Sae Kwon Chang, Hwaseong-si (KR); Joo Seung Lee, Hwaseong-si (KR)

(73) Assignees: HYUNDAI MOTOR COMPANY, Seoul (KR); KIA CORPORATION, Seoul (KR)

(21) Appl. No.: 19/190,317

(22) Filed: Apr. 25, 2025

(30) Foreign Application Priority Data
Dec. 4, 2024 (KR) 10-2024-0178585

(51) Int. Cl. B60L 58/30; B60L 50/75; H01M 8/04858; H02M 3/08; H02M 3/145

(52) U.S. Cl. CPC B60L 58/30; B60L 50/75; H01M 8/04865; H02M 3/08; H02M 3/145; B60L 2210/14

(57) ABSTRACT

A method of controlling a fuel cell vehicle including a fuel cell and a voltage level conversion unit including a plurality of boost converters configured to boost stack voltage generated by the fuel cell includes determining whether the level of the output from the voltage level conversion unit increases or decreases. The method also includes reducing the number of boost converters to be operated among the N boost converters in accordance with the magnitude of a voltage command value based on determining that the output level increases. The method additionally includes increasing the number of boost converters to be operated among the N boost converters in accordance with the magnitude of the voltage command value based on determining that the output level decreases.

### CROSS-REFERENCE TO RELATED APPLICATION

This application claims the benefit of and priority to Korean Patent Application No. 10-2024-0178585, filed on Dec. 4, 2024, which is hereby incorporated by reference as if fully set forth herein.

### BACKGROUND

### Field of the Disclosure

The present disclosure relates to a fuel cell vehicle and a method of controlling the same.

### Discussion of the Related Art

A fuel cell vehicle includes a fuel cell and a high-voltage boost DC/DC converter (or a fuel cell DC/DC converter (FDC)). The FDC is a boost converter that controls power output from the fuel cell. Due to the FDC, the fuel cell may not be influenced by operation or stop of high-voltage components of the vehicle or loads, such as an inverter and a drive motor.

The FDC may control the voltage and the current of a cell stack of the fuel cell to regulate power output from the cell stack. Even when a load connected to an output end of the FDC stops operation, the cell stack of the fuel cell may generate only desired output due to the FDC. If output from the loads of the vehicle is greater than output from the cell stack, power may be emitted from a high-voltage battery, and if output from the loads of the vehicle is less than output from the cell stack, the high-voltage battery may store power. Thus, output from the cell stack of the fuel cell may be controlled regardless of variation in output from the loads, whereby the cell stack may be reliably protected, and the durability thereof may be ensured.

In order to reduce the costs of components of the FDC (i.e., an inductor, a capacitor, a semiconductor switch, and a diode), a plurality of boost converters may be connected in parallel to each other to implement an FDC (hereinafter referred to as a “multiphase FDC”).

### SUMMARY

Embodiments of the present disclosure are directed to a fuel cell vehicle and a method of controlling the same that substantially obviate one or more problems due to limitations and disadvantages of the related art.

Embodiments of the present disclosure provide a fuel cell vehicle capable of efficiently driving a plurality of boost converters and a method of controlling the same.

However, the objects to be accomplished by the present disclosure are not limited to the above-mentioned objects. Other objects not mentioned herein should be more clearly understood by those having ordinary skill in the art from the following description.

Additional advantages, objects, and features of the disclosure are set forth in part in the description which follows and in part should become more apparent to those having ordinary skill in the art upon examination of the following description or may be learned from practice of the present disclosure. The objectives and other advantages of the present disclosure may be realized and attained by the structure particularly pointed out in the written description and the appended drawings, as well as the appended claims and equivalents thereof.

According to an embodiment, a method of controlling a fuel cell apparatus is provided. The fuel cell apparatus includes a fuel cell and a voltage level conversion unit including a plurality of boost converters configured to boost stack voltage generated by the fuel cell. The method includes determining whether the level of the output from the voltage level conversion unit increases or decreases. The method also includes reducing the number of boost converters to be operated among the plurality of boost converters in accordance with the magnitude of a voltage command value based on determining that the level of the output increases. The method further includes increasing the number of boost converters to be operated among the plurality of boost converters in accordance with the magnitude of the voltage command value based on determining that the level of the output decreases.

In an example, the plurality of boost converters includes N boost converters.

In an example, increasing the number of boost converters may include operating only one of the N boost converters based on determining that the level of the output decreases and the voltage command value is greater than or equal to a first lower threshold. Increasing the number of boost converters may also include setting a variable n to 1 and determining whether the voltage command value is greater than or equal to an n+1^{th} lower threshold less than an n^{th} lower threshold and is less than the n^{th} lower threshold. Increasing the number of boost converters may further include operating n+1 boost converters among the N boost converters upon determining that the voltage command value is greater than or equal to the n+1^{th} lower threshold and less than the n^{th} lower threshold. Increasing the number of boost converters may also include determining whether n+2 is less than N upon determining that the voltage command value is less than the n+1^{th} lower threshold. Increasing the number of boost converters may additionally include operating the N boost converters upon determining that n+2 is N and the voltage command value is less than the n+1^{th} lower threshold. Increasing the number of boost converters may further include increasing n by 1 and proceeding to determining whether n+2 is less than N upon determining that n+2 is less than N.

In an example, reducing the number of boost converters may include operating the N boost converters upon determining that the level of the output increases and the voltage command value is less than an N^{th} upper threshold. Reducing the number of boost converters may also include setting a variable k to N and determining whether the voltage command value is less than a k−1^{th} upper threshold greater than a k^{th} upper threshold and is greater than or equal to the k^{th} upper threshold. Reducing the number of boost converters may additionally include operating k−1 boost converters among the N boost converters upon determining that the voltage command value is less than the k−1^{th} upper threshold greater than the k^{th} upper threshold and is greater than or equal to the k^{th} upper threshold. Reducing the number of boost converters may further include determining whether k−2 is greater than 1 upon determining that the voltage command value is greater than the k−1^{th} upper threshold. Reducing the number of boost converters may also include operating only one of the N boost converters upon determining that k−2 is 1 and the voltage command value is greater than the k−1^{th} upper threshold. Reducing the number of boost converters may further include reducing k by 1 and proceeding to determining whether k−2 is greater than 1 upon determining that k−2 is greater than 1.

In an example, the method may further include determining whether operation of the voltage level conversion unit is required and receiving the voltage command value.

In an example, the method may further include receiving a new voltage command value after sequentially reducing or increasing the number of boost converters.

In an example, the first lower threshold, the n^{th} lower threshold, and the n+1^{th} lower threshold may be determined in advance.

In an example, the N^{th} upper threshold, the k−1^{th} upper threshold, and the k^{th} upper threshold may be determined in advance.

In an example, the number of boost converters may be sequentially increased.

In an example, the number of boost converters may be sequentially reduced.

In an example, the voltage command value may be determined in consideration of the relationship between the voltage command value and a current command value mapped in advance.

In an example, the plurality of boost converters are connected in parallel with each other.

In an example, the fuel cell apparatus further comprises a battery configured to store voltage output from the voltage level conversion unit

According to another embodiment, a fuel cell vehicle comprises a fuel cell including a cell stack and configured to generate stack voltage, a voltage level conversion unit including N (N being a positive integer greater than or equal to 2) boost converters configured to boost the stack voltage generated by the fuel cell in response to a control signal and connected in parallel to each other, a battery configured to store voltage output from the voltage level conversion unit, and a controller. The controller is configured to generate the control signal to increase or reduce the number of boost converters to be operated among the N boost converters in accordance with the magnitude of a voltage command value depending on whether the level of the output from the voltage level conversion unit increases or decreases.

It should be understood that both the foregoing general description and the following detailed description of the present disclosure are illustrative and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram of a fuel cell vehicle according to an embodiment;

FIG. 2 is a view for explaining an embodiment of a fuel cell DC/DC converter (FDC) shown in FIG. 1;

FIG. 3 is a circuit diagram of an embodiment of the FDC shown in FIG. 2;

FIG. 4 is a flowchart for explaining a method of controlling the fuel cell vehicle according to an embodiment;

FIG. 5 is a hysteresis characteristics graph;

FIG. 6 is a flowchart of an embodiment of a step of reducing a number of boost converters shown in the method of FIG. 4;

FIG. 7 is a flowchart of an embodiment of increasing a number of boost converters in the method of FIG. 4;

FIG. 8 shows a controller of a fuel cell vehicle according to a comparative example;

FIG. 9 shows a controller of the fuel cell vehicle according to an embodiment; and

FIG. 10 shows a power density curve and a current-voltage (I-V) curve of a fuel cell.

### DETAILED DESCRIPTION

Embodiments of the present disclosure are described more fully hereinafter with reference to the accompanying drawings, in which various embodiments are shown. The present disclosure, however, may be embodied in many different forms, and should not be construed as being limited to the embodiments set forth herein. Rather, these embodiments are provided to make the present disclosure thorough and complete, and to fully convey the scope of the present disclosure to those having ordinary skill in the art.

It should be understood that when an element is referred to as being “on” or “under” another element, the element may be directly on/under the other element, or one or more intervening elements may also be present.

When an element is referred to as being “on” or “under”, “under the element” as well as “on the element” may be included based on the element.

In addition, relational terms, such as “first”, “second”, “on/upper part/above”, and “under/lower part/below”, are used only to distinguish between one subject or element and another subject or element, without necessarily requiring or involving any physical or logical relationship or sequence between the subjects or elements.

In the present disclosure, when a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, module, apparatus, and the like may separately embody or be included with a processor and a memory, such as a non-transitory computer readable media, as part of the apparatus.

Hereinafter, a fuel cell vehicle according to embodiments is described in more detail with reference to the accompanying drawings.

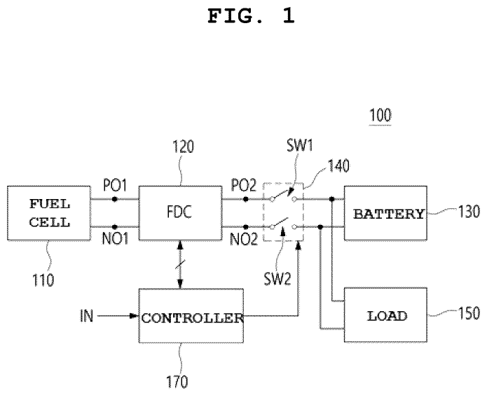

FIG. 1 is a block diagram of a fuel cell vehicle 100 according to an embodiment. The fuel cell vehicle 100 may include a fuel cell 110, a voltage level conversion unit 120, a battery (or a high-voltage battery) 130, and a controller 170.

The fuel cell 110 may include a plurality of unit fuel cells. The plurality of unit fuel cells may be stacked in at least one of a vertical direction or a horizontal direction. The unit fuel cell may be a polymer electrolyte membrane fuel cell (or a proton exchange membrane fuel cell) (PEMFC), which has been studied most extensively as a power source for driving fuel cell vehicles. However, the embodiments are not limited to any specific form, configuration, or appearance of the unit fuel cell.

The unit fuel cell included in the fuel cell 110 may include end plates (pressing plates or compression plates) (not shown), current collectors (not shown), and a cell stack (not shown).

The cell stack may include, for example, a plurality of unit cells stacked in the horizontal direction. Tens to hundreds of unit cells, for example, 100 to 400 unit cells, may be stacked to form the cell stack. The number of unit fuel cells included in the fuel cell 110 and the number of unit cells included in the cell stack of the unit fuel cell may be determined depending on the intensity of power to be supplied from the fuel cell 110 to a load 150. The load 150 may be a part or component that requires power in the fuel cell vehicle 100. The load 150, according to an embodiment, is described in more detail below.

The end plates may be disposed at respective ends of the cell stack and may support and fix the plurality of unit cells. For example, a first end plate may be disposed at one of the two opposite ends of the cell stack and a second end plate may be disposed at the other of the two opposite ends of the cell stack.

In addition, the fuel cell 110 may further include a clamping member (not shown). The clamping member may comprise a bar shape, a long bolt shape, a belt shape, or a rigid rope shape to clamp the plurality of unit cells. For example, in each unit fuel cell, the clamping member may serve to clamp the plurality of unit cells in the horizontal direction together with the end plates.

The voltage level conversion unit 120 may boost the stack voltage generated by the fuel cell 110 in response to a control signal and may output the boosted voltage to the battery 130 or the load 150. For example, the voltage level conversion unit 120 may include a high-voltage boost direct current to direct current (DC/DC) converter (or a fuel cell DC/DC converter (FDC)). Hereinafter, the voltage level conversion unit 120 is generally referred to as an “FDC”.

Generally, the FDC 120 may perform operation of matching the stack voltage generated by the fuel cell 110 with the voltage stored in the battery 130, i.e., operation of adjusting the stack voltage to the voltage range of the battery 130. For example, while the level of the stack voltage is about 100 V to about 200 V, the voltage level of the battery 130 is about 600 V. Thus, the FDC 120 may operate as a type of boost converter that boosts the stack voltage to 600 V.

The battery 130 stores the boosted voltage output from the FDC 120.

The controller 170 may serve to generate a control signal to control the operation of the FDC 120. In addition, the controller 170 may control transfer of the boosted voltage from the FDC 120 to the battery 130. The fuel cell vehicle 100 may further include a switching unit 140. Under the control of the controller 170, the switching unit 140 may be switched on to supply the boosted voltage to the battery 130. For example, the switching unit 140 may include a first switch (or relay) SW1 and a second switch (or relay) SW2. The first switch SW1 and the second switch SW2 may be disposed between the FDC 120 and the battery 130 and may be switched under the control of the controller 170.

In addition, the fuel cell vehicle 100 according to an embodiment may further include the load 150. The load 150 may include an inverter (not shown) and a motor (not shown). The inverter may be connected to the boosted voltage, may convert DC voltage received from the FDC 120 into alternating current (AC) voltage in accordance with the driving state of the fuel cell vehicle 100, and may output the AC voltage to the motor. The motor may operate in response to the AC voltage output from the inverter. In other words, the motor may rotate in response to the AC voltage for the motor received from the inverter, thereby performing a function of driving the fuel cell vehicle 100. For example, the motor may be a three-phase AC rotating device that includes a rotor in which permanent magnets are embedded. However, the embodiments are not limited to any specific form of the main output unit, the inverter, or the motor.

In addition, although not shown in the drawings, the fuel cell vehicle 100 may further include peripheral auxiliary devices (balance-of-plant (BOP)) and high-voltage components.

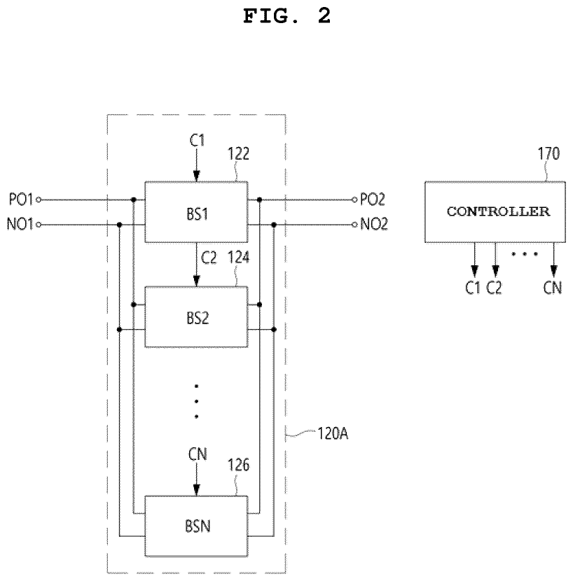

FIG. 2 is a view for explaining an FDC 120A, according to an embodiment. The FDC 120A may correspond to the FDC 120 shown in FIG. 1, in an embodiment. The FDC 120A and the controller 170 shown in FIG. 2 correspond to and perform the same functions as the FDC 120 and the controller 170 shown in FIG. 1, respectively, and thus a duplicate description thereof has been omitted.

Referring to FIG. 2, the FDC 120A may be a “multiphase FDC” including a plurality of first to N^{th} boost converters (BS1 to BSN) 122 to 126 connected in parallel to each other, where N is a positive integer greater than or equal to 2.

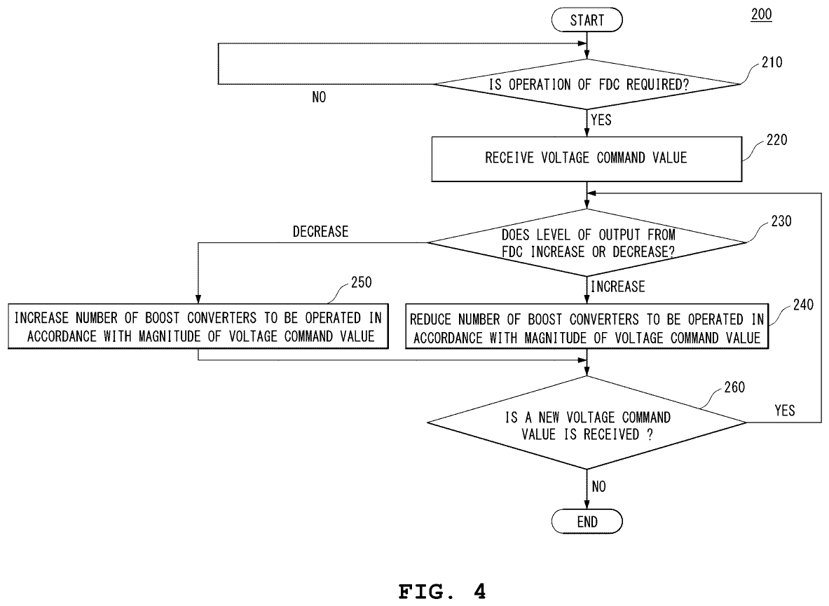

According to an embodiment, the controller 170 may generate control signals C1 to CN to increase or reduce the number of boost converters to be operated among the first to N^{th} boost converters (BS1 to BSN) 122-126 in response to the magnitude of a voltage command value depending on whether the level of the output from the multiphase FDC 120A increases or decreases. A method in which the controller 170 controls the first to N^{th} boost converters (BS1 to BSN) 122-126 using the control signals C1 to CN, according to an embodiment, is described in more detail below with reference to FIGS. 4-6.

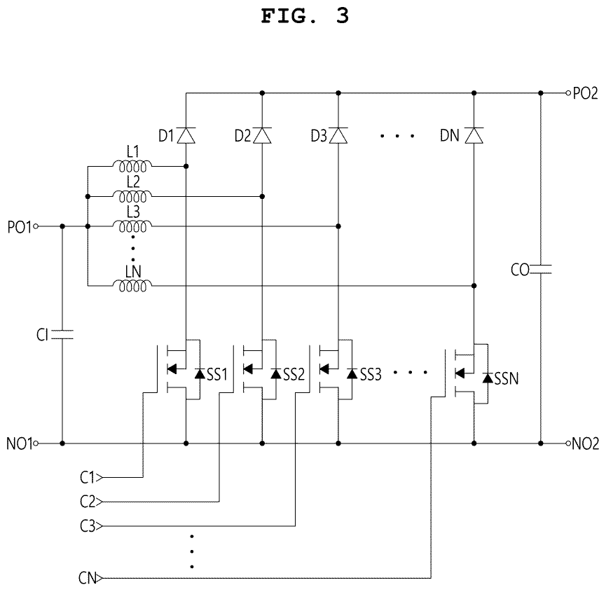

FIG. 3 is a circuit diagram of the FDC 120A shown in FIG. 2, according to an embodiment.

The FDC 120A shown in FIG. 3 may include an input capacitor CI, first to N^{th} inductors L1-LN, first to N^{th} diodes D1-DN, first to N^{th} semiconductor switches SS1-SSN, and an output capacitor CO.

The input capacitor CI may be connected between the positive output terminal PO1 and the negative output terminal NO1 of the fuel cell 110.

Each of the first to N^{th} inductors L1-LN has an end connected to the positive output terminal PO1.

Each of the first to N^{th} diodes D1 to DK has a positive electrode connected to the other end of a respective one of the first to N^{th} inductors L1-LN.

The output capacitor CO may be connected between the negative electrode of each of the first to N^{th} diodes D1-DN and the negative output terminal NO1.

The first to N^{th} semiconductor switches SS1-SSN may be connected between the positive electrode of each of the first to N^{th} diodes D1 to DN and the negative output terminal NO1. For example. Each (SSj) of the first to N^{th} semiconductor switches SS1-SSN may be switched on (or turned on) or switched off (or turned off) in response to a j^{th} control signal Cj, and may be connected between the other end of the j^{th} inductor Lj and the negative output terminal NO1 of the fuel cell 110. The j^{th} semiconductor switch SSj may include a gate connected to the j^{th} control signal Cj, a drain connected to the other end of the j^{th} inductor Lj, and a source connected to the negative output terminal NO1. Here, 1≤j≤N.

Each (SSj) of the first to N^{th} semiconductor switches SS1-SSN may be implemented as an insulated gate bipolar transistor (IGBT) or a field effect transistor (FET). For example, each (SSj) of the first to N^{th} semiconductor switches SS1-SSN may be implemented as a transistor, as shown in FIG. 3.

The power output from the FDC 120 may generally be about 200 kW (600 A). However, inductors, capacitors, switches, and diodes capable of withstanding this level of current and power are not present, or are very expensive even if present. However, as shown in FIGS. 2 and 3, if the boost converters are connected in parallel to each other to implement the FDC 120 as the multiphase FDC 120A, the output power per boost converter among the boost converters connected in parallel may be reduced from 200 kW to 200 kW/N, whereby the prices of the components (i.e., the inductor, the capacitor, the semiconductor switch, and the diode) of each boost converter may be reduced.

In addition, with the N boost converters BS1-BSN are arranged in parallel as shown in FIG. 3, only a desired number of boost converters among the boost converters BS1-BSN disposed in parallel may be operated according to the output power when the fuel cell vehicle 100 is actually driven. For example, if the power output from the FDC 120A is 70 kW, only two boost converters among the N boost converters may be operated, and the remaining boost converters may be not operated. Alternatively, if the power output from the FDC 120A is 140 kW, only three boost converters among the N boost converters may be operated, and the remaining boost converters may be not operated. In this way, if the number of boost converters operated according to the power output from the multiphase FDC 120A is varied, the overall efficiency of the FDC may be increased.

For example, if the power output from the FDC is 200 kW (600 A) and four (N=4) boost converters are arranged in parallel, the capacity per boost converter may be designed and manufactured to be 50 kW (150 A).

Hereinafter, a method 200 of controlling the fuel cell vehicle according to an embodiment is described in more detail with reference to the accompanying drawings. For convenience of description, the method 200 shown in FIG. 4 is described as being performed by the fuel cell vehicle 100 shown in FIG. 1. However, the method 200 shown in FIG. 4 may be performed by a fuel cell vehicle configured differently from the fuel cell vehicle 100 shown in FIG. 1, in other embodiments.

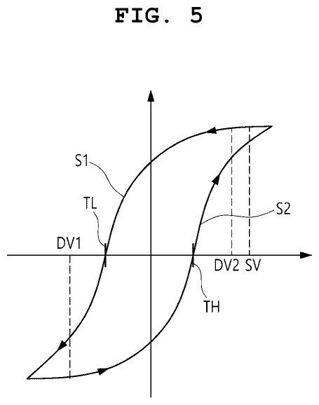

FIG. 4 is a flowchart for explaining the method 200 of controlling the fuel cell vehicle according to the embodiment. and FIG. 5 is a hysteresis characteristics graph indicating a voltage command value.

The method 200 shown in FIG. 4 may be performed by the controller 170 shown in FIG. 1.

In the method 200 of controlling the fuel cell vehicle according to the embodiment, in a step or operation 210, it may be determined whether operation of the FDC 120 or 120A is required.

If operation of the FDC 120 or 120A is required, the controller 170 receives a voltage command value in a step or operation 220. The voltage command value may be provided to the controller 170 from an upper-level controller (not shown), for example.

For example, the controller 170 may be requested to operate the FDC 120 or 120A through the input terminal IN, and may receive the voltage command value. Accordingly, execution of the method 200 shown in FIG. 4 may commence upon operation of the FDC 120 or 120A. According to the control method 200 of the embodiment, when the FDC operation command is received, the voltage command is followed.

In a step or operation 230, it is determined whether the level of the output from the FDC 120 or 120A increases or decreases. For example, based on the hysteresis characteristics graph shown in FIG. 5, it is determined whether the output level is in a decreasing state (hereinafter referred to as a first state) S1 or an increasing state (hereinafter referred to as a second state) S2.

If the output level is in the first state S1, i.e., the decreasing state, the method 200 may proceed to a step or operation S250, in which the number of boost converters to be operated among the N boost converters (BS1-BSN) 122-126 may be increased according to the magnitude of the voltage command value.

On the other hand, if the output level is in the second state S2, i.e., the increasing state, the method 200 may processed to a step or operation S240, in which the number of boost converters to be operated among the N boost converters (BS1 to BSN) 122 to 126 may be reduced according to the magnitude of the voltage command value.

As described above, according to an embodiment, a driving constant is determined according to the magnitude of the voltage command value. In an embodiment, the driving constant is the number of boost converters to be operated among the plurality of boost converters. For example, if the driving constant is j-phase, the number of boost converters to be operated among the first to N^{th} boost converters is j. As an example, if the driving constant is 1-phase (j=1), the number of boost converters to be operated among the plurality of boost converters is one, and if the driving constant is 2-phase (j=2), the number of boost converters to be operated among the plurality of boost converters is two.

Referring to the hysteresis shown in FIG. 5, if the input value exceeds the upper threshold TH, the process enters a subsequent state. However, because the lower threshold TL is different from the upper threshold TH, even when the same value SV is input, the result varies depending on the states (i.e., S1 and S2). In addition, when different values DV1 and DV2 are input according to the respective states (i.e., S1 and S2), the same result is obtained.

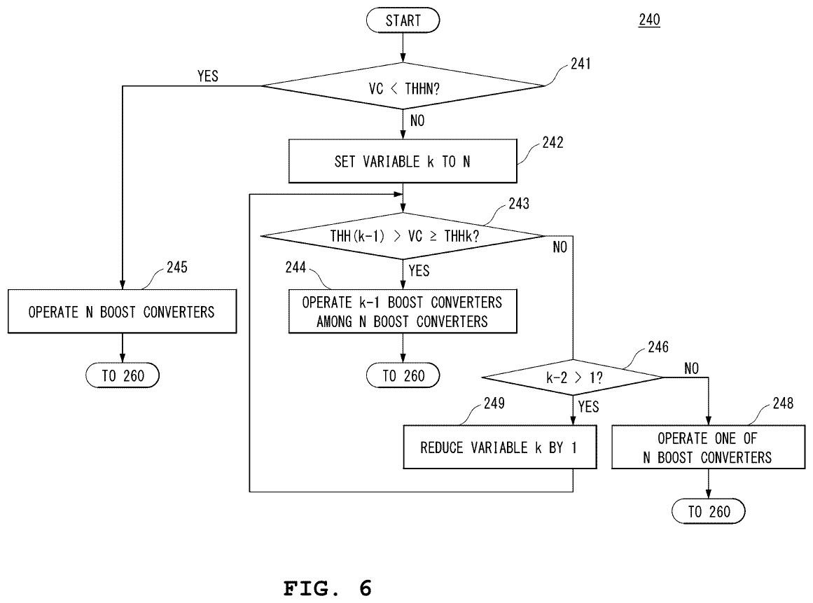

FIG. 6 is a flowchart of a process of reducing a number of boost converters at the step or operation 240 of FIG. 4, according to an embodiment.

In a step or operation 241, if the level of the output from the FDC 120 or 120A increases, it is determined whether the voltage command value VC is less than an N^{th} upper threshold THHN.

If the voltage command value VC is less than the N^{th} upper threshold THHN, all of the N boost converters (BS1-BSN) 122-126 are operated in a step or operation 245. In other words, the driving constant is determined to be N.

However, if the voltage command value VC is not less than the N^{th} upper threshold THHN, a variable k is set to N in a step or operation 242.

In a step or operation S243, it is determined whether the voltage command value VC is less than a k−1^{th} upper threshold THH(k−1) and greater than or equal to a k^{th} upper threshold THHk is determined. In an embodiment, the k−1^{th} upper threshold THH(k−1) is a value greater than the k^{th} upper threshold THHk.

If the voltage command value VC is less than the k−1^{th} upper threshold THH(k−1) and greater than or equal to the k^{th} upper threshold THHk, k−1 boost converters among the N boost converters (BS1-BSN) 122-126 are operated in a step or operation 244. In other words, the driving constant is determined to be k+1. However, if the voltage command value VC is not less than the k−1^{th} upper threshold THH(k−1) but greater than the k−1^{th} upper threshold THH(k−1), in a step or operation S246, it is determined whether k−2 is greater than 1.

If the voltage command value VC is greater than the k−1^{th} upper threshold THH(k−1) and if k−2 is not greater than or is equal to 1, only one of the N boost converters (BS1 to BSN) 122 to 126 is operated in a step or operation 248. In other words, the driving constant is determined to be 1.

However, if k−2 is greater than 1, k is reduced by 1 in a step or operation 249, and the process proceeds to the step or operation 243. Thereafter, steps or operations 243, 244, 246, and 248 are repeatedly performed.

According to an embodiment, as shown in FIG. 6, when the level of the output from the FDC 120 or 120A increases, the number of boost converters to be operated is sequentially reduced. For example, after three boost converters among the N boost converters (BS1-BSN) 122-126 are operated, two boost converters may be operated, and then one boost converter may be operated, rather than operating one boost converter immediately after the operation of three boost converters. Accordingly, the driving constant may be changed from 3-phase to 2-phase and then changed to 1-phase, rather than being directly changed from 3-phase to 1-phase.

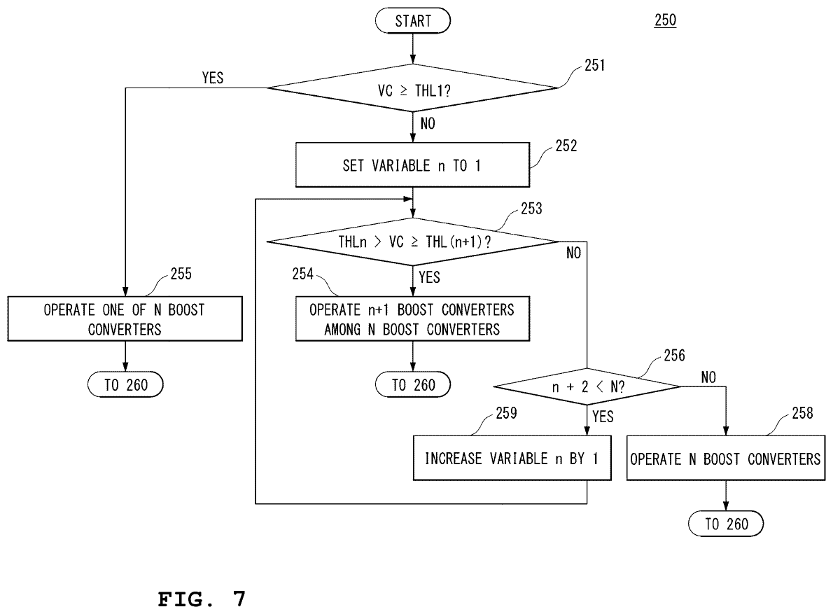

FIG. 7 is a flowchart of a process of increasing a number of boost converters at the step or operation 250 of FIG. 4, according to an embodiment.

If the level of the output from the FDC 120 decreases, it is determined whether the voltage command value VC is greater than or equal to a first lower threshold THL1 in a step or operation S251.

If the voltage command value VC is greater than or equal to the first lower threshold THL1, only one of the N boost converters (BS1-BSN) 122 to 126 is operated in a step or operation 255.

However, if the voltage command value VC is less than the first lower threshold THL1, a variable n is set to 1 in a step or operation 252.

In a step or operation S253, it is determined whether the voltage command value VC is greater than or equal to an n+1^{th} lower threshold THL(n+1) and less than an n^{th} lower threshold THLn is determined. In an embodiment, the n+1^{th} lower threshold THL(n+1) is a value less than the n^{th} lower threshold THLn.

If the voltage command value VC is greater than or equal to the n+1^{th} lower threshold THL(n+1) and less than the n^{th} lower threshold THLn, n+1 boost converters among the N boost converters (BS1-BSN) 122-126 are operated in a step 254. In other words, the driving constant is determined to be n+1.

If the voltage command value VC is less than the n+1^{th} lower threshold THL(n+1), it is determined whether n+2 is less than N in ta step or operation S256.

If the voltage command value THL(n+1) is less than the n+1^{th} lower threshold THL(n+1) and if n+2 is not less than or is equal to N in step 256, all of the N boost converters (BS1-BSN) 122-126 are operated in a step or operation 258.

However, if the voltage command value is less than the n+1^{th} lower threshold and if n+2 is less than N, n is increased by 1 in a step or operation S259, and the process proceeds to the step or operation step 253. Thereafter, steps 253, 254, 256, 257, 258, and 259 are repeatedly performed.

According to an embodiment, as shown in FIG. 7, when the level of the output from the FDC 120 decreases, the number of boost converters to be operated is sequentially increased. For example, after one of the N boost converters (BS1-BSN) 122-126 is operated, two boost converters may be operated, and then three boost converters may be operated, rather than operating three boost converters immediately after the operation of one boost converter. Accordingly, the driving constant may be changed from 1-phase to 2-phase and then changed to 3-phase, rather than being directly changed from 1-phase to 3-phase.

According to an embodiment, the N^{th}, k−1^{th}, and k^{th} upper thresholds THHN, THH(k−1), and THHk and the first, n^{th}, and n+1^{th} lower thresholds THL1, THLn, and THL(n+1) may be determined for each driving constant. For example, the first lower threshold THL1 and the first upper threshold THH1 when the driving constant is 1-phase may be determined, the second lower threshold THL2 and the second upper threshold THH2 when the driving constant is 2-phase may be determined, and the j^{th} lower threshold THLj and the j^{th} upper threshold THHj when the driving constant is j-phase may be determined.

According to an embodiment, when the driving constant is reduced, the upper threshold is used as shown in FIG. 6, and when the driving constant is increased, the lower threshold is used as shown in FIG. 7.

Hereinafter, in order to aid in understanding steps 240 and 250 shown in FIGS. 6 and 7, FIGS. 6 and 7 are described with reference to an example in which the stack voltage of the fuel cell 110 has a level between 350 volts and 600 volts, N is 3, THH 3 (corresponding to THHN shown in FIG. 6) is 450 volts, THH2 (corresponding to THH(k−1) shown in FIG. 6) is 550 volts, THL 1 is 500 volts, and THL 2 (corresponding to THL(n+1) shown in FIG. 7) is 400.

First, referring to FIG. 6, when the level of the output from the FDC 120 increases, it is determined whether the voltage command value VC is less than 450 volts, which is the third upper threshold THH3, in the step or operation 241. If the voltage command value VC is less than the third upper threshold THH3, all of the three boost converters (BS1 to BS3) 122 to 126 are operated in the step or operation 245.

However, if the voltage command value VC is not less than 450 volts, which is the third upper threshold THH3, the variable k is set to 3 in the step or operation 242.

In the step or operation S243, it is determined whether the voltage command value VC is less than 550 volts, which is the second upper threshold THH2, and greater than or equal to 450 volts, which is the third upper threshold THH3.

If the voltage command value VC is less than 550 volts, which is the second upper threshold THH2, and greater than or equal to 450 volts, which is the third upper threshold THH3, two of the three boost converters (BS1-BS3) 122-126 are operated in the step or operation 244.

However, if the voltage command value VC is not less than 550 volts, which is the second upper threshold THH2, but greater than 550 volts, it is determined whether k−2 is greater than 1 in the step or operation 246. In this case, because k is set to 3, which is N, in the step or operation 242, k−2 is 1. Therefore, only one of the three boost converters (BS1-BS3) 122-126 is operated in the step or operation 248.

If the level of the output from the FDC 120 or 120A decreases, it is determined whether the voltage command value VC is greater than or equal to 500 volts, which is the first lower threshold THL1, in the step or operation 251.

If the voltage command value VC is greater than or equal to 500 volts, which is the first lower threshold THL1, only one of the three boost converters (BS1 to BS3) 122 to 126 is operated in the step or operation 255.

However, if the voltage command value VC is less than 500 volts, which is the first lower threshold THL1, the variable n is set to 1 in the step or operation 252.

In the step or operation S253, it is determined whether the voltage command value VC is greater than or equal to 400 volts, which is the second lower threshold THL2, and less than 500 volts, which is the first lower threshold THL1. If the voltage command value VC is greater than or equal to 400 volts, which is the second lower threshold THL2, and less than 500 volts, which is the first lower threshold THL1, two of the three boost converters (BS1-BS3) 122-126 are operated in the step or operation 254.

However, if the voltage command value VC is less than 400 volts, which is the second lower threshold THL2, it is determined whether n+2 is less than N in the step or operation step 256. Because n is set to 1 in step 252, n+2 is 3. Therefore, all of the three boost converters (BS1-BS3) 122-126 are operated in the step or operation 258.

Referring again to FIG. 4, after step 240 of sequentially reducing the number of boost converters or step 250 of sequentially increasing the number of boost converters is performed, it is determined whether a new voltage command value is received in a step or operation 260. If a new voltage command value is received, steps 230-250 described above are repeatedly performed.

In addition, according to an embodiment, with respect to the same voltage command value VC, the driving constant may decrease or increase depending on whether the level of the output from the FDC 120A increases or decreases. For example, if the voltage command value VC is 520 volts, the driving constant is determined to be 2-phase when the level of the output from the FDC 120A increases, and the driving constant is determined to be 1-phase when the level of the output from the FDC 120A decreases. In addition, if the voltage command value VC is 420 volts, the driving constant is determined to be 3-phase when the level of the output from the FDC 120A increases and thus the driving constant decreases, and the driving constant is determined to be 2-phase when the level of the output from the FDC 120A decreases and thus the driving constant increases. Therefore, even when a microvoltage value varies based on 500 V, which is the threshold, the driving constant does not decrease or increase. Accordingly, the driving constant of the FDC 120A may be stably changed even while the fuel cell vehicle is driven.

Hereinafter, the fuel cell vehicle according to an embodiment of the present disclosure is described in comparison with a fuel cell vehicle according to a comparative example.

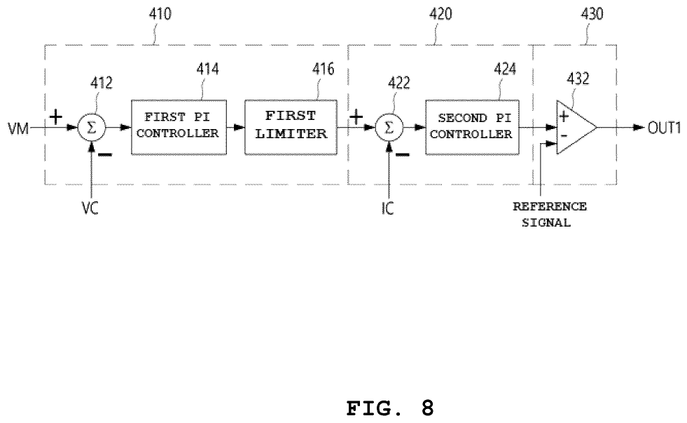

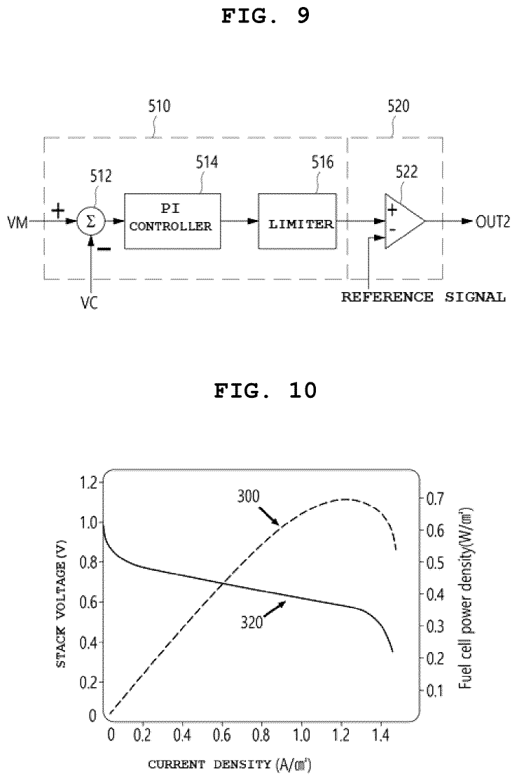

FIG. 8 shows a controller of the fuel cell vehicle according to the comparative example. FIG. 9 shows a controller of the fuel cell vehicle according to an embodiment of the present disclosure.

The controller shown in FIG. 8 serves to control each of a plurality of boost converters included in a multiphase FDC. To this end, the controller includes a voltage control unit 410, a current control unit 420, and a pulse width modulation (PWM) signal generation unit 430.

The voltage control unit 410 includes a first subtractor 412, a first proportional integral (PI) controller 414, and a first limiter 416.

The first subtractor 412 subtracts a voltage command value VC from a voltage measurement value VM, and outputs a result of the subtraction to the first PI controller 414. Here, the voltage measurement value is, for example, a voltage measured from each of the plurality of boost converters shown in FIG. 3.

The first PI controller 414 proportionally integrates the result of subtraction by the first subtractor 412, and outputs a result of the proportional integration to the first limiter 416.

The first limiter 416 limits the level of the result of the proportional integration by the first PI controller 414, and outputs a result of the limit to the current control unit 420.

A second subtractor 422 of the current control unit 420 subtracts a current command value IC from the output from the voltage control unit 410, and outputs a result of the subtraction to a second PI controller 424. The second PI controller 424 proportionally integrates the result of the subtraction by the second subtractor 422, and outputs a result of the proportional integration to the PWM signal generation unit 430.

A comparator 432 of the PWM signal generation unit 430 compares the output from the current control unit 420 with a reference signal, and outputs a result of the comparison to a corresponding one of the plurality of boost converters through an output terminal OUT1. For example, the reference signal may be a ground signal.

The controller shown in FIG. 9 may be an embodiment of a part of the controller 170 shown in FIG. 1 that generates a control signal Cj for controlling the FDC shown in FIG. 3. Accordingly, the controller shown in FIG. 9 controls each (BSj) of the N boost converters BS1 to BSN 122 to 126 included in the multiphase FDC 120A shown in FIG. 3, in an embodiment.

The controller shown in FIG. 9 includes a voltage control unit 510 and a PWM signal generation unit 520. The voltage control unit 510 includes a subtractor 512, a proportional integral (PI) controller 514, and a limiter 516, and the PWM signal generation unit 520 includes a comparator 522.

The voltage control unit 510 and the PWM signal generation unit 520 shown in FIG. 9 may perform the same functions as the voltage control unit 410 and the PWM signal generation unit 430 shown in FIG. 8, respectively. Therefore, the subtractor 512, the proportional integral (PI) controller 514, the limiter 516, and the comparator 522 perform the same functions as the subtractor 412, the first PI controller 414, the first limiter 416, and the comparator 432 shown in FIG. 8, respectively, and thus a duplicate description thereof has been omitted.

In the case of the fuel cell vehicle according to the comparative example, as the input current value increases in the multiphase FDC including the plurality of boost converters connected in parallel, the driving constant increases. Therefore, as shown in FIG. 8, in the case of the comparative example, both voltage control and current control must be performed, and thus both the voltage control unit 410 and the current control unit 420 are required.

In the case of the comparative example, if the stack malfunctions during operation of the multiphase FDC, the current limit value decreases. When the current limit value decreases below the voltage limit value, the current limit value is transmitted, and accordingly, an error accumulates in the voltage control unit 410, whereby the voltage control unit 410 is saturated. Because the voltage control unit 410 in the saturated state is not capable of operating, only the current control unit 420 operates. When the malfunction of the stack is released during the above operation, the current limit value increases. As the error of the converted voltage control unit 410 approaches 0, the voltage control unit 410 operates normally again. As described above, in the case of the comparative example, the process of controlling the multiphase FDC is complicated, and is not implemented quickly.

In contrast, according to an embodiment of the present disclosure, the voltage command value VC is determined in consideration of the relationship between the current command value and the voltage command value mapped in the upper-level controller (not shown), and the determined voltage command value VC is output to the voltage control unit 510 shown in FIG. 9.

FIG. 10 shows a power density curve 300 and a current-voltage (I-V) curve 320 of the fuel cell.

Referring to FIG. 10, a general boost converter receives a command value in the form of current, voltage, or a power value that the converter should output. In the case of a fuel cell, once the voltage or the current is determined, the remaining current or voltage and the power density value corresponding thereto are determined depending on the characteristics of the fuel cell, as shown in FIG. 10. Therefore, from the perspective of the boost converter, if control of at least one of the voltage or the current is implemented effectively, control of the remaining voltage or current and the power is naturally achieved. The upper-level controller may determine the voltage command value VC in consideration of the current command value using the curve 320 indicating the relationship between the current and the voltage shown in FIG. 10.

Examples of a method of controlling the FDC include a voltage control method and a current control method. If the current is received as the command value, the driving constant may be increased as the input current increases.

According to the control method 200 of the embodiment, upon receiving the voltage command value from the upper-level controller, the controller 170 may determine the driving constant in inverse proportion to the voltage command value. For example, if the voltage command value decreases, the driving constant is increased, and if the voltage command value increases, the driving constant is reduced. In addition, the current that the fuel cell is capable of outputting is limited depending on the state of the fuel cell. According to the embodiment, the FDC 120 may be controlled without a separate conversion process.

Therefore, in the case of an embodiment, if the stack malfunctions during operation of the multiphase FDC 120A, the current command value is received only as a current limit value, and does not affect the operation of the multiphase FDC 120A. Thereafter, if the malfunction of the stack is released, the current limit value increases, but the multiphase FDC is identically controlled only with the voltage command value, and thus operates without any difference from the normal operational state. As described above, unlike the comparative example, according to an embodiment of the present disclosure, the process of controlling the multiphase FDC may be simplified.

In addition, in the case of the comparative example, because the driving constant is determined in conjunction with navigation, the driving constant may not be determined in real time but may be determined or changed after stop of the vehicle.

However, in the case of an embodiment of the present disclosure, the driving constant is determined only with the voltage command value. In addition, when the driving constant is determined, the hysteresis characteristics shown in FIG. 5 may be applied. Therefore, the driving constant may be determined or changed in real time even during travel of the vehicle, whereby the efficiency of the converter may be increased. For example, according to the method 200 of controlling the fuel cell vehicle according to the embodiment, the plurality of boost converters is selectively driven in accordance with the voltage command value, and thus the efficiency of the FDC 120A may be increased.

In the case in which the driving constant is determined without using the hysteresis characteristics, if the actual sensing value varies due to noise or the command value slightly varies depending on the state of the fuel cell 110, operations of increasing and reducing the driving constant based on a predetermined boundary point are repeatedly performed while repeating the previous state and the current state. Accordingly, the power value output from one semiconductor switch SSj greatly varies, thus increasing switching ripple. Further, the switch SSj, which commences switching, continuously performs operations of outputting a predetermined amount of power and power of 0 kW, and thus has a huge burden.

In contrast, according to an embodiment of the present disclosure, a desired driving constant may not change instantaneously but may be controlled accurately within a desired output range using the hysteresis characteristics. Due to these characteristics of the embodiment, even while the vehicle is driven, the driving constant may be controlled, and the FDC may operate in response thereto. As a result, the stability of the FDC may be ensured.

Consequently, according to an embodiment, because the FDC is controlled based on the driving constant determined in accordance with the magnitude of the voltage command value, the FDC may operate with high efficiency. Further, because the hysteresis characteristics are utilized for each driving constant, the operational stability of the FDC may be ensured, and thus the FDC may operate even during travel of the fuel cell vehicle. Furthermore, because the driving constant is determined based on the voltage command value, it may be possible to control the driving constant without conversion into a power value or a current value, to improve the durability of the semiconductor switch of each boost converter through control for each driving constant, and to immediately implement control without a separate conversion process in response to a current limit command.

A fuel cell vehicle such as the cell vehicle 100 according to embodiments described above may also be applied to aircraft, ships, stationary power generation systems, etc., but the disclosure is not limited thereto.

As is apparent from the above description, according to a fuel cell vehicle and a method of controlling the same according to embodiments, an FDC is controlled based on a driving constant determined in accordance with the magnitude of a voltage command value, and accordingly, the FDC may operate with high efficiency. Further, because the hysteresis characteristics are utilized for each driving constant, the operational stability of the FDC may be ensured, and thus the FDC may operate even during travel of the fuel cell vehicle. Furthermore, because the driving constant is determined based on a voltage command value, it may be possible to control the driving constant without conversion into a power value or a current value, to improve the durability of a semiconductor switch of each boost converter through control for each driving constant, and to immediately implement control without a separate conversion process in response to a current limit command.

However, the effects achievable by embodiments of the present disclosure are not limited to the above-mentioned effects, and other effects not mentioned herein should be more clearly understood by those having ordinary skill in the art from the above description.

The above-described various embodiments may be combined with each other without departing from the scope of the present disclosure unless they are incompatible with each other.

In addition, for any element or process that is not described in detail in any of the various embodiments, reference may be made to the description of an element or a process having the same reference numeral in another embodiment, unless otherwise specified.

While the present disclosure has been particularly shown and described with reference to illustrative embodiments thereof, these embodiments are only proposed for illustrative purposes, and do not restrict the present disclosure. It should be apparent to those having ordinary skill in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims.

What is claimed is:

1. A method of controlling a fuel cell apparatus comprising a fuel cell and a voltage level conversion unit including a plurality of boost converters configured to boost stack voltage generated by the fuel cell, the method comprising:
determining whether a level of output from the voltage level conversion unit increases or decreases;
reducing a number of boost converters to be operated among the plurality of boost converters in accordance with a magnitude of a voltage command value based on determining that the level of the output increases; and
increasing the number of boost converters to be operated among the plurality of boost converters in accordance with the magnitude of the voltage command value based on determining that the level of the output decreases.

2. The method according to claim 1, wherein the plurality of boost converters includes N boost converters, wherein increasing the number of boost converters includes, and wherein N is a positive integer greater than or equal to 2:
operating only one of the N boost converters based on determining that the level of the output decreases and the voltage command value is greater than or equal to a first lower threshold;
setting a variable n to 1;
determining whether the voltage command value is greater than or equal to an n+1^{th} lower threshold less than an n^{th} lower threshold and is less than the n^{th} lower threshold;
operating n+1 boost converters among the N boost converters based on determining that the voltage command value is greater than or equal to the n+1^{th} lower threshold and less than the n^{th} lower threshold;
determining whether n+2 is less than N based on determining that the voltage command value is less than the n+1^{th} lower threshold;
operating the N boost converters based on determining that n+2 is N and the voltage command value is less than the n+1^{th} lower threshold; and
increasing n by 1 and proceeding to determining whether the voltage command value is greater than or equal to the n+1^{th} lower threshold and is less than the n^{th} lower threshold.

3. The method according to claim 1, wherein the plurality of boost converters includes N boost converters, wherein N is a positive integer greater than or equal to 2, and wherein reducing the number of boost converters includes:
operating the N boost converters based on determining that the level of the output increases and the voltage command value is less than an N^{th} upper threshold;
setting a variable k to N;
determining whether the voltage command value is less than a k−1^{th} upper threshold greater than a k^{th} upper threshold and is greater than or equal to the k^{th} upper threshold;
operating k−1 boost converters among the N boost converters based on determining that the voltage command value is less than the k−1^{th} upper threshold greater than the k^{th} upper threshold and is greater than or equal to the k^{th} upper threshold;
determining whether k−2 is greater than 1 based on determining that the voltage command value is greater than the k−1^{th} upper threshold;
operating only one of the N boost converters based on determining that k−2 is 1 and the voltage command value is greater than the k−1^{th} upper threshold; and
reducing k by 1 and proceeding to determining whether the voltage command value is less than the k−1^{th} upper threshold and is greater than or equal to the k^{th} upper threshold.

4. The method according to claim 1, further comprising:
determining whether operation of the voltage level conversion unit is required; and
receiving the voltage command value.

5. The method according to claim 4, further comprising receiving a new voltage command value after sequentially reducing or increasing the number of boost converters.

6. The method according to claim 2, wherein the first lower threshold, the n^{th} lower threshold, and the n+1^{th} lower threshold are determined in advance.

7. The method according to claim 3, wherein the N^{th} upper threshold, the k−1^{th} upper threshold, and the k^{th} upper threshold are determined in advance.

8. The method according to claim 1, wherein the number of boost converters is sequentially increased.

9. The method according to claim 1, wherein the number of boost converters that are operated is sequentially reduced.

10. The method according to claim 1, wherein the voltage command value is determined based on a relationship between the voltage command value and a current command value mapped in advance.

11. The method of claim 1, wherein the plurality of boost converters are connected in parallel with each other.

12. The method of claim 1, wherein the fuel cell apparatus further comprises a battery configured to store voltage output from the voltage level conversion unit.

13. A fuel cell vehicle comprising:
a fuel cell including a cell stack, the fuel cell being configured to generate stack voltage;
a voltage level conversion unit including N boost converters configured to boost the stack voltage generated by the fuel cell in response to a control signal, wherein N is a positive integer greater than or equal to 2; and
a controller configured to generate the control signal to increase or reduce a number of boost converters to be operated among the N boost converters in accordance with a magnitude of a voltage command value depending on whether a level of output from the voltage level conversion unit increases or decreases.

14. The fuel cell vehicle of claim 13, wherein the N boost controllers are connected in parallel to each other.

15. The fuel cell vehicle of claim 13, further comprising a battery configured to store voltage output from the voltage level conversion unit.
